(19) United States
(12) Patent Application Publication
(10) Pub. No.: US 2023/0370409 A1
(43) Pub. Date: Nov. 16, 2023

(54) PRESENTING CONTENT HISTORY TO A USER ADDED TO A GROUP CHAT

(71) Applicant: INTERNATIONAL BUSINESS MACHINES CORPORATION, Armonk, NY (US)

(72) Inventors: HEMANT KUMAR SIVASWAMY, PUNE (IN); AKASH U. DHOOT, PUNE (IN); VENKATA VARA PRASAD KARRI, VISAKHAPATNAM (IN); SHAILENDRA MOYAL, PUNE (IN)

(21) Appl. No.: 17/743,623

(22) Filed: May 13, 2022

(51) Int. Cl. H04L 51/216; G06F 40/20; G06F 21/62

(52) U.S. Cl. CPC H04L 51/216; G06F 21/62; G06F 40/20

(57) ABSTRACT

Presenting content history to a user added to a group chat may include: receiving a request from a user to join an existing group chat session, wherein the requesting user is associated with user data describing the requesting user’s persona; performing an analysis of content of the group chat session prior to the requesting user joining the group chat session; and adding the requesting user to the group chat session, including: generating a modified version of the content of the group chat session based on the content analysis and the user data; and presenting the modified version of the content of the group chat session to the requesting user.

### BACKGROUND

### Field of the Disclosure

The field of the disclosure is data processing, or, more specifically, methods, apparatus, and products for presenting content history to a user added to a group chat.

### Description of Related Art

The development of the EDVAC computer system of 1948 is often cited as the beginning of the computer era. Since that time, computer systems have evolved into extremely complicated devices. Today’s computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Group chat sessions may be hosted by a group chat application utilized by multiple users to communicate with one another. Users may be added to existing group chat sessions that have already had conversation taking place. When a user is added to an existing group chat session, the added user may be presented with the content of the group chat session which took place prior to the user joining the session. Such content history may include content that does not pertain to, provide interest to, the added user, or may contain sensitive or private information not suitable for the added user.

### SUMMARY

Apparatus and systems for presenting content history to a user added to a group chat according to various embodiments are disclosed in this specification. Presenting content history to a user added to a group chat may include: receiving a request from a user to join an existing group chat session, wherein the requesting user is associated with user data describing the requesting user’s persona; performing an analysis of content of the group chat session prior to the requesting user joining the group chat session; and adding the requesting user to the group chat session, including: generating a modified version of the content of the group chat session based on the content analysis and the user data; and presenting the modified version of the content of the group chat session to the requesting user.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 a block diagram of an example computing system configured for presenting content history to a user added to a group chat in accordance with embodiments of the present disclosure.

FIG. 2 shows a line drawing of an example group chat application GUI configured for presenting content history to a user added to a group chat in accordance with embodiments of the present disclosure.

FIG. 3 is a flowchart of an example method for presenting content history to a user added to a group chat according to some embodiments of the present disclosure.

FIG. 4 is a flowchart of an example method for presenting content history to a user added to a group chat according to some embodiments of the present disclosure.

FIG. 5 is a flowchart of an example method for presenting content history to a user added to a group chat according to some embodiments of the present disclosure

### DETAILED DESCRIPTION

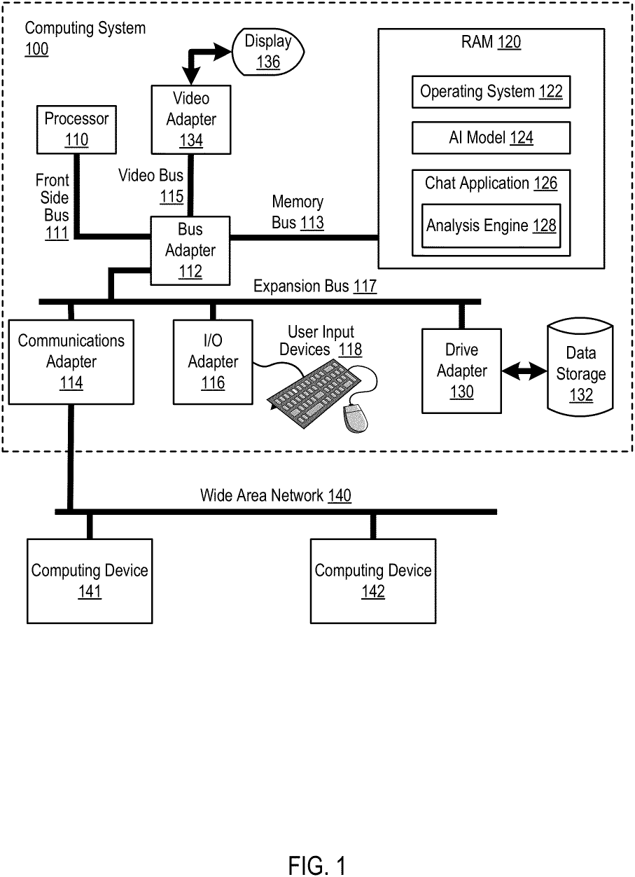

Exemplary apparatus and systems for presenting content history to a user added to a group chat in accordance with the present disclosure are described with reference to the accompanying drawings, beginning with FIG. 1. FIG. 1 sets forth a block diagram of automated computing machinery comprising an exemplary computing system 100 configured for presenting content history to a user added to a group chat according to embodiments of the present disclosure. The computing system 100 of FIG. 1 includes at least one computer processor 110 or ‘CPU’ as well as random access memory (‘RAM’) 120 which is connected through a high speed memory bus 113 and bus adapter 112 to processor 110 and to other components of the computing system 100.

Stored in RAM 120 is an operating system 122. Operating systems useful in computers configured for presenting content history to a user added to a group chat according to embodiments of the present disclosure include UNIXTM, LinuxTM, Microsoft WindowsTM, AIXTM, and others as will occur to those of skill in the art. The operating system 122 in the example of FIG. 1 is shown in RAM 120, but many components of such software typically are stored in non-volatile memory also, such as, for example, on data storage 132, such as a disk drive. Also stored in RAM is an artificial intelligence (AI) model 124, including machine learning algorithms and other types or rules-based predictive algorithms and techniques useful for presenting content history to a user added to a group chat according to embodiments of the present disclosure.

Also stored in RAM is a chat application 126 configured for presenting content history to a user added to a group chat according to embodiments of the present disclosure. The chat application 126 is a computer program configured to allow for group messaging between multiple users within a single messaging interface, where each of the users in the group are a part of the conversation. The example group chat application of FIG. 1 may include an analysis engine configured to perform an analysis on content of the group chat, such as the conversation between the users of the group.

The computing system 100 of FIG. 1 includes disk drive adapter 130 coupled through expansion bus 117 and bus adapter 112 to processor 110 and other components of the computing system 100. Disk drive adapter 130 connects non-volatile data storage to the computing system 100 in the form of data storage 132. Disk drive adapters useful in computers configured for inserting sequence numbers into editable tables according to embodiments of the present disclosure include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computing system 100 of FIG. 1 includes one or more input/output (‘I/O’) adapters 116. I/O adapters implement user-oriented input/output through, for example, software drivers and computer hardware for controlling output to display devices such as computer display screens, as well as user input from user input devices 118 such as keyboards and mice. The example computing system 100 of FIG. 1 includes a video adapter 134, which is an example of an I/O adapter specially designed for graphic output to a display device 136 such as a display screen or computer monitor. Video adapter 134 is connected to processor 110 through a high speed video bus 115, bus adapter 112, and the front side bus 111, which is also a high speed bus.

The exemplary computing system 100 of FIG. 1 includes a communications adapter 114 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for inserting sequence numbers into editable tables according to embodiments of the present disclosure include modems for wired dial-up communications, Ethernet (IEEE 802.3) adapters for wired data communications, and 802.11 adapters for wireless data communications.

The communications adapter 114 of FIG. 1 is communicatively coupled to a wide area network 140 that also includes other computing devices, such as computing devices 141 and 142 as shown in FIG. 1. Example computing devices 141 and 142 may also include the chat application 126 and may be computing devices of other users that are part of a group chat session. For example, a user of the computing system 100 interacting with a graphical user interface (‘GUI’) of the chat application 126 may request to be added to an existing group chat session, where the existing group chat session includes users of computing devices 141 and 142 which also include the chat application 126.

Continuing with the above example, the chat application 126 of FIG. 1 may add the requesting user to the existing group chat session and present the content history of the existing group chat session to the user for viewing the conversation taking place within the session prior to the requesting user joining. In one embodiment, the chat application 126 may present the requesting user with a modified version of the content history based on an analysis of the group chat session content performed prior to joining the requesting user to the session. For example, the chat application may determine, based on the analysis of the group chat session content, that a portion of the content contains sensitive information which requires a specific level of security clearance. The chat application 126 may determine, upon receiving the user’s request to join the group chat session, that the requesting user has a security clearance level that does not meet the level of security clearance required to view the sensitive information included within the content history of the existing group chat session. The chat application, upon determining that the requesting user is not cleared to view a portion of the content history of the session, may add the user to the group chat session and present, to the user, an altered version of the content history which hides the sensitive information from the user’s view.

In the above example, the chat application 126 of FIG. 1 presents a modified version of the content of the group chat session to the requesting user by hiding or masking sensitive information included within the content from the view of the user based on the security clearance levels associated with both the content and the requesting user. In another embodiment, the chat application may replace the sensitive information with different information. For example, the chat application may modify the content history by replacing the sensitive information with a summary of the information that excludes the details of the sensitive information, thereby lowering the security clearance level required to view the summary of the sensitive information to meet the security clearance of the requesting user. In another embodiment, the chat application may replace a portion of the content history with a notification indicating the presence of removed content.

In another embodiment, the chat application 126 of FIG. 1 may present a modified version of the content of the group chat session to the requesting user by summarizing any technical information which the chat application determines would not be understood by the requesting user, where the determination is made based on the user’s role and area of expertise included in the user data associated with the requesting user. In another embodiment, the chat application 126 may present a modified version of the content of the group chat session to the requesting user by masking or summarizing any content that may be considered offensive to the requesting user, where such content is determined based on the analysis of the content performed by the analysis engine 128 and based on the user data of the requesting user. The analysis engine 128 may be included within the chat application 126, as shown in FIG. 1, or may be external to the chat application within RAM 120 or on a remote system.

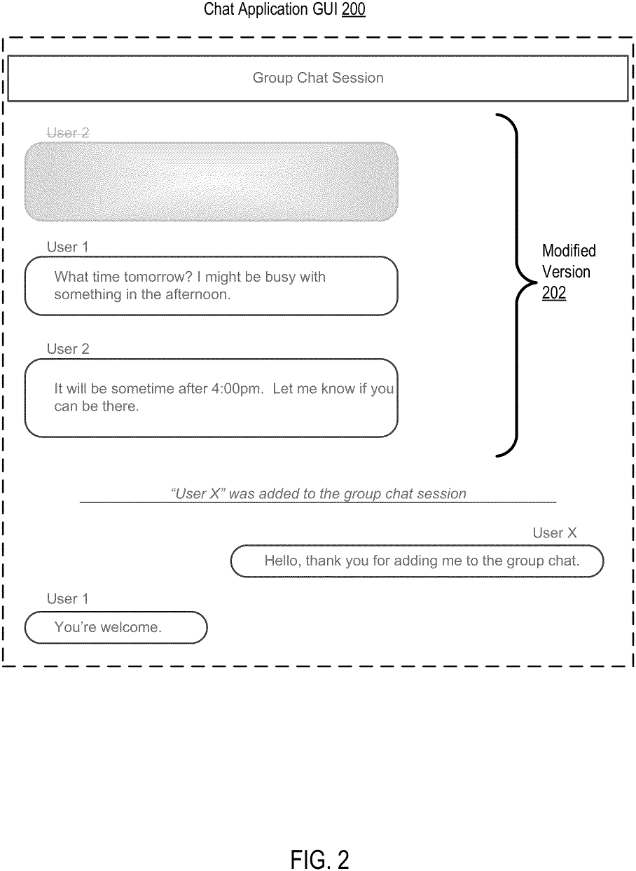

For further explanation, FIG. 2 sets forth a line drawing of an example chat application GUI 200 configured for presenting content history to a user added to a group chat according to embodiments of the present disclosure. The example chat application GUI 200 of FIG. 2 shows an example presentation of a modified version 202 of the content of the group chat session as viewed by the requesting user that has been added to the group chat session. The chat application GUI 200 may be accessed by a user device, such as computing system 100 of FIG. 1. In the example GUI 200 of FIG. 2, the chat application shows a notification that is sent to all the members of the group chat session indicating that the requesting user has been added to the group chat session. In the example GUI 200 of FIG. 2, the user added to the existing group chat session may view only the modified version 202 of the content history of the group chat session, where the modified version has a portion of the content modified. In the example embodiment shown in FIG. 2, the modified version 202 has a portion of the content blurred out so as to be masked from view by the added user. In other embodiments, the modified portion of content within the modified version 202 may be removed entirely, masked from view, or replaced with alternative content.

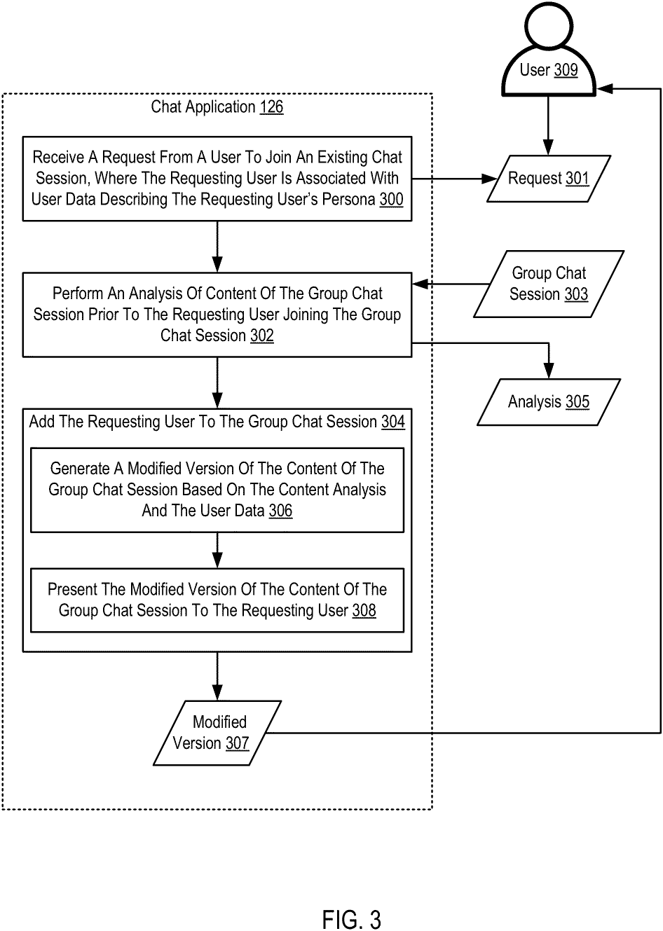

For further explanation, FIG. 3 sets forth a flowchart illustrating an example method of presenting content history to a user added to a group chat according to embodiments of the present disclosure. The method of FIG. 3 includes receiving 300 a request 301 from a user 309 to join an existing group chat session 303. In the method of FIG. 3, the requesting user 309 is associated with user data describing the requesting user’s persona. The example group chat session 303 of FIG. 3 may be hosted by the chat application utilized by multiple users to communicate with one another, where the chat application is configured to present communication content to the multiple users within the session. The group chat session 303 may include content from the users within the session prior to the user requesting to join the session. The example request 301 from the user 309 to join an existing group chat session 303 may be received by the chat application 126 via a GUI 200 of the chat application and may include identity information associated with the user 309. The request 301 may also identify the existing group chat session 303 for which the user is requesting admission to.

The user data associated with the requesting user 309 may be stored locally on the computing system 100 or on a cloud-based platform associated with the chat application 126. The user data may include identity information associated with the user. The chat application 126, upon receiving the request 301 from the user 309, may use the identity information included within the request 301 to identify the corresponding user data having matching identity information. The user data associated with the user may also include information describing a persona of the user. Such information included within the user data may include information relating to the user’s employment, such as the user’s job title, areas of expertise, security clearance, a list of projects that the user is currently a part of the user’s role in each of those projects, and the like. The user data may also include information relating to the user’s personal life, such as a list of the user’s family members or friends, a relationship status of the user and corresponding identity information, native languages, and the like. The sum of the information included within the user data may describe the persona of the user 309.

The method of FIG. 3 also includes performing 302 an analysis of content of the group chat session 303. In the method of FIG. 3, the analysis 305 of content of the group chat session 303 is performed prior to the requesting user 309 joining the group chat session 303. Performing 302 the analysis of the content of the group chat session may be carried out by the chat application 126 requesting an analysis 305 of the group chat session content from the analysis engine 128. The analysis engine 128 may, in response to analyzing the content, generate a completed analysis 305 of the content for the chat application 126. The analysis 305 of the content of the group chat session may include generating and assigning content tags to portions of the content. Content tags may describe a category or a context of the corresponding portion of content to which the tag is assigned. For example, a portion of the content of the group chat session discussing personal information about a user may be assigned a ‘personal information’ content tag. Other examples of different types of content tags assigned to portions of the content may include a ‘security tag’ assigned to content related to sensitive information requiring a specific security clearance to view, a ‘technical support’ tag assigned to portions of content useful to technical support personnel to perform corresponding services, a ‘technical data’ tag assigned to portions of content containing technical details likely to be understood by users with a particular area of expertise, an ‘offensive content’ tag assigned to portions of content deemed by the analysis engine as potentially offensive to one or more users, a ‘management content’ tag assigned to content applicable only to users in management roles, a ‘project ID’ tag assigned to portions of the content related to a particular project being discussed, and the like. Readers of skill will understand that many other types or categories of content tags not disclosed herein may be applied to portions of content according to embodiments of the present disclosure. The example analysis 305 of FIG. 3 may be generated by the analysis engine in response to performing 302 an analysis of the content of the group chat session and may be stored within memory local to the chat application 126 or on a cloud-based platform associated with the chat application 126.

The method of FIG. 3 also includes adding 304 the requesting user 309 to the group chat session 303. Adding 304 the requesting user to the group chat session may be carried out by sending the requesting user a session key associated with the group chat session and admitting the user into the group chat session. Adding 304 the requesting user to the group chat session may also include sending a notification to the other users of the group chat session indicating that the requesting user has been added to the group chat session.

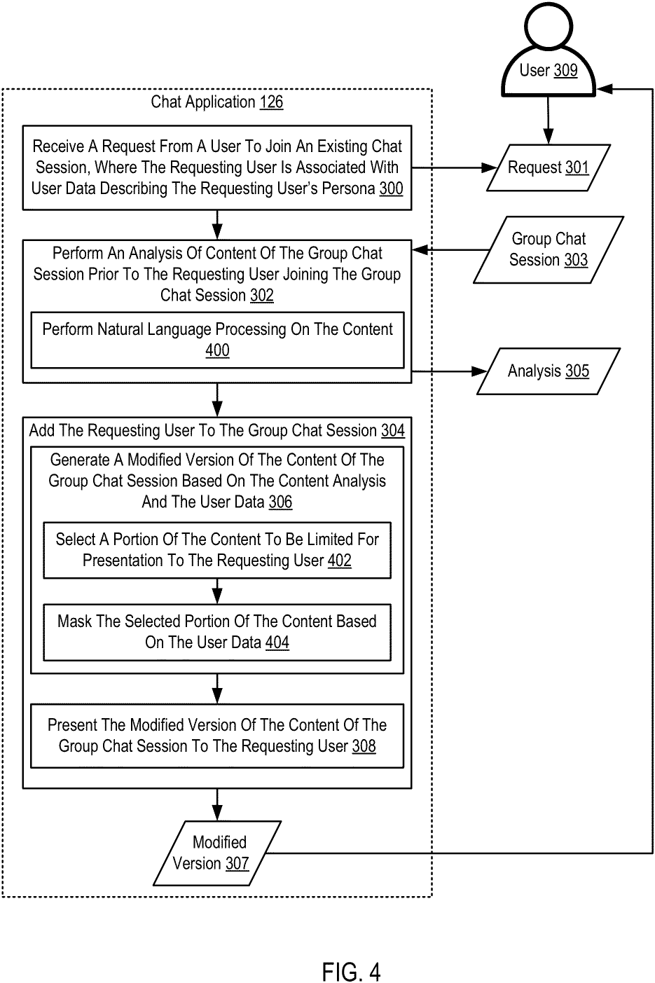

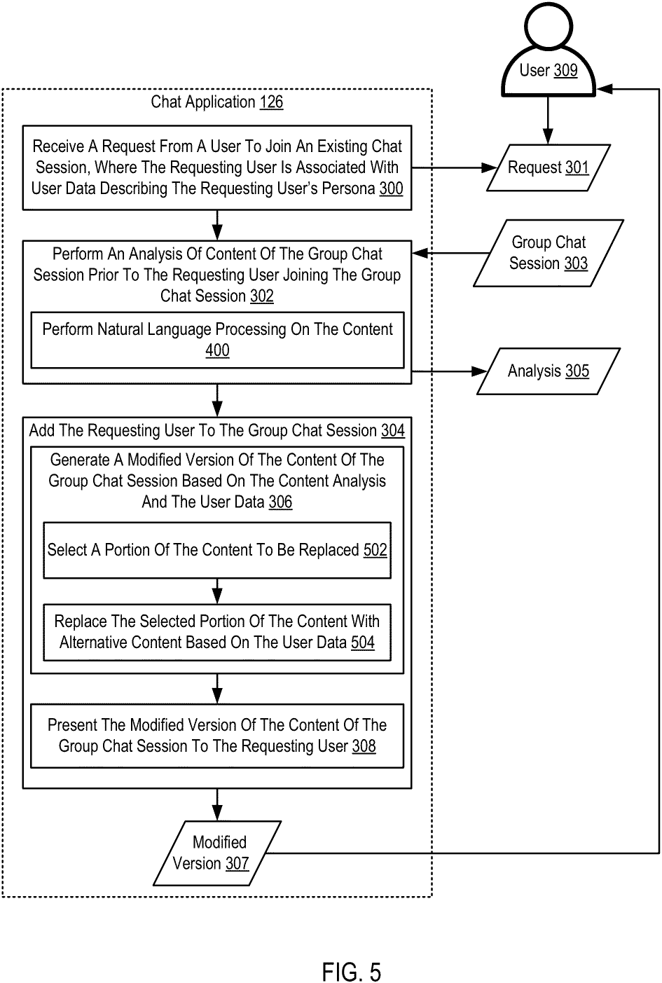

The method of FIG. 3 also includes, as part of adding 304 the requesting user to the group chat session, generating 306 a modified version 307 of the content of the group chat session based on the analysis 305 of the session content and the user data associated with the requesting user 309. The modified version 307 generated by the chat application may have one or more portions of the session content modified or removed from presentation to the user based on the analysis and the user data (see FIG. 4 and FIG. 5 for more detail). The analysis engine may determine to modify or remove the one or more portions of the session content from presentation based on assigned content tags and the user data of the requesting user. For example, the analysis engine may determine to modify portions of the session content that are assigned with a security tag, where the assigned security tags identify portions of content requiring a higher security clearance level than what the requesting user possesses according to the user data. In another example, the analysis engine may determine to modify portions of the session content with assigned management tags in response to determining that the requesting user is not within a management role, according to the user data. In another example, the analysis engine may determine to modify portions of the session content with assigned project ID tags in response to determining that the requesting user is not associated with the project identified by the project ID tags. In another example, the analysis engine may determine to modify portions of the session content with assigned project ID tags in response to determining the requesting user’s ‘project role’ relating to the project identified by the project ID tags. In another example, the analysis engine may determine to modify portions of the session content with assigned offensive content tags in response to determining that the portions of content are potentially offensive to the requesting user.

The method of FIG. 3 also includes, as part of adding 304 the requesting user to the group chat session, presenting 308 the modified version 307 of the content of the group chat session to the requesting user 309. Presenting 308 the modified version to the requesting user may be carried out by the chat application presenting the generated modified version 307 to the user via a GUI 200 of the chat application. When presenting 308 the modified version to the requesting user, the modified portions of the session content may be presented in a number of different ways. In one example, the modified portions of the session content may be presented to the user by replacing the modified portions with alternative content (see FIG. 5 for more detail). In another example, the modified portions of the session content may be presented to the user by masking the modified portions from the requesting user’s view (see FIG. 4 for more detail). The analysis engine may determine, prior to presenting 308 the modified version, how to present the modified portions of the session content to the user, such as a determination of whether to replace or mask the portions of content to be modified for presentation.

In some embodiments of the present disclosure, the chat application 126 may be configured to allow one or more of the users already part of the existing group chat session override the modified version being presented to the requesting user upon being added to the group chat. Specifically, a user may override the analysis engine’s presentation of the content history to the requesting user by allowing the requesting user to see the unmodified version of the content history. In such an example, a user may override the analysis engine based on information included within such a user’s associated user data, such as a user’s job title or project role. For example, a manager user or a project lead user may override the analysis engine’s presentation of the modified version by allowing a newly added user to view the unmodified version of the session content history. In another embodiment, a user may override the analysis engine’s presentation of the modified version by selecting specific portions of the session content history which may be presented to the newly added user in its original unmodified view.

In some embodiments of the present disclosure, the chat application 126 may be configured to notify one or more of the users already part of the existing group chat session of the portions of session content history which were modified for view by the newly added user. In such an embodiment, the one or more users notified may be selected based on information included within such a user’s associated user data, such as a user’s job title or project role. For example, a project lead included in an existing group chat session may be notified of which portions of content were modified, and how the portions were modified, within the modified version presented to a newly added user joining the group chat session.

For further explanation, FIG. 4 sets forth a flowchart illustrating an example method of presenting content history to a user added to a group chat according to embodiments of the present disclosure. The method of FIG. 4 continues with the method of FIG. 3 by further including, as part of performing 302 an analysis of content of the group chat session, performing 400 natural language processing (NLP) on the content. Performing 400 NLP on the content may be carried out by the analysis engine 128 analyzing the session content using natural-language understanding (‘NLU’) and extracting contextual information from the content and organizing the content based on their context. Organizing the content may include assigned content tags to portions of the content according to embodiments of the present disclosure. In one embodiment, NLP may be performed on the content of the group chat session as the session content is being generated, such as throughout the life of the group chat session. In another embodiment, the performing of NLP on the content of the group chat session may be triggered by receiving the request from the requesting user to join the group chat session.

The method of FIG. 4 also includes, as part of generating 306 a modified version of the content of the group chat session, selecting 402 a portion of the content to be limited for presentation to the requesting user. Selecting 402 a portion of the content to be limited for presentation to the requesting user may be carried out by parsing the content and determining which portions to limit based on assigned content tags within the analysis 305 and the user data of the requesting user.

The method of FIG. 4 also includes, as part of generating 306 a modified version of the content of the group chat session, masking 404 the selected portion of the content based on the user data. Masking 404 the selected portion of the content based on the user data may be carried out by comparing the selected content with the user data and determining that the selected portions of the content should be hidden from the view of the user. For example, the analysis engine may compare a security clearance level included within the user data with a security clearance level identified by security tags assigned to portions of the session content and determine that the portions should be masked from view of the user based on the user’s security clearance level not meeting the level indicated by the security tags. In another example, the analysis engine may compare a user’s role identified within the user data with a content tags assigned to portions of the session content and determine to mask any portions of the session content not associated with the user’s role. For example, a technical support personnel admitted into the group chat conversation to review technical problems that have been discussed in a project meeting may only be presented with the portions of content relating to the technical problem to be solved, where the remaining portions of the session content are masked from view by the technical support personnel admitted into the group chat conversation.

For further explanation, FIG. 5 sets forth a flowchart illustrating an example method of presenting content history to a user added to a group chat according to embodiments of the present disclosure. The method of FIG. 5 continues with the method of FIG. 3 by further including, as part of generating 306 a modified version of the content of the group chat session, selecting 502 a portion of the content to be replaced. Selecting 502 a portion of the content to be replaced may be carried out by parsing the content and determining which portions to limit based on assigned content tags within the analysis 305 and the user data of the requesting user.

The method of FIG. 5 also includes, as part of generating 306 a modified version of the content of the group chat session, replacing 504 the selected portion of the content with alternative content based on the user data. Replacing 504 the selected portion of the content with alternative content based on the user data may be carried out by comparing the selected content with the user data and determining alternative content that should replace the selected portions of the content for view by the user. The alternative content may be a notification of the presence of modified content, an indication of the content tag associated with the modified or masked content, a summary of the modified content, and the like. In one embodiment, the analysis engine may compare a security clearance level included within the user data with a security clearance level identified by security tags assigned to portions of the session content and determine, based on the user’s security clearance level not meeting the level indicated by the security tags, that the portions should be replaced with alternative content. In such an example, the alternative content may include a notification indicating to the user that he does not meet security clearance requirements to view such portions of content. The alternative content may also include a summary of the portions of selected content that excludes particular details of the selected portions, thereby lowering the security clearance level required to view the summary of the selected portions of content to meet the security clearance of the requesting user. Generating alternative content within the modified version 307 including such a summary may include determining which particular details within the selected portions could be removed from view by the user to sufficiently lower the security clearance requirement enough to present to the requesting user.

In another embodiment, the analysis engine may compare a user’s role identified within the user data with content tags assigned to portions of the session content and determine to replace any portions of the session content not associated with the user’s role with alternative content. For example, a technical support personnel admitted into the group chat conversation to review technical problems that have been discussed in a project meeting may only be presented with the portions of content relating to the technical problem to be solved, where the remaining portions of the session content are masked from view by the technical support personnel admitted into the group chat conversation by being replaced with alternative content. In such an example, the alternative content may indicate to the technical support personnel that such portions of content are not intended for their view or may include a summary of the selected portions of content.

In another embodiment, the analysis engine may compare a user’s ‘project role’, identified within the user data and relating to a specific project, with project ID tags assigned to portions of the session content and determine to replace one or more portions of the session content with alternative content. For example, a user admitted into the group chat conversation, where the user’s project role identifies the user as a marketing manager for the project, may only be presented with project-related portions of the session content that are determined, by the analysis engine, as being useful to the marketing manager, where the remaining project-related portions of the session content are replaced with alternative content including only a summarized version of the content. In another example, a user admitted into the group chat conversation, where the user’s project role identifies the user as a lead for the project, may be presented with all of the project-related portions of the session content.

In another embodiment, the analysis engine may determine to replace selected portions of the session content having assigned offensive content tags, in response to determining that the portions of content are potentially offensive to the requesting user, with alternative content. In such an example, the alternative content may replace offensive language with alternative language deemed less offensive by the analysis engine while still maintaining the context of the content.

In view of the explanations set forth above, readers will recognize that the benefits of presenting content history to a user added to a group chat according to embodiments of the present disclosure include:
Increasing chat application performance by displaying only a portion of the content history to a user added to a group chat session by modifying the content history of the session for view by the requesting user.
Increasing computing system security by hiding sensitive information from users added to a group chat not having clearance to view such sensitive information.

Exemplary embodiments of the present disclosure are described largely in the context of a fully functional computer system for optimizing network load in multicast communications. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method for presenting content history to a user added to a group chat, the method comprising:
receiving a request from a requesting user to join an existing group chat session, wherein the requesting user is associated with user data describing the requesting user’s persona;
performing an analysis of content of the group chat session prior to the requesting user joining the group chat session; and
adding the requesting user to the group chat session, including:
generating a modified version of the content of the group chat session based on the content analysis and the user data, including modifying content history of the group chat session to be presented to the requesting user based on natural language processing (NLP) analysis of the content history; and
presenting the modified version of the content of the group chat session to the requesting user.

2. The method of claim 1, wherein the user data comprises an identity of the requesting user and a role of the requesting user.

3. The method of claim 1, wherein performing the analysis of the content of the group chat session includes performing natural language processing (NLP) on the content.

4. The method of claim 3, wherein performing NLP on the content includes generating content tags associated with the content.

5. The method of claim 3, wherein performing NLP on the content includes generating security tags associated with the content.

6. The method of claim 1, wherein generating the modified version of the content of the group chat session includes selecting a portion of the content to be limited for presentation to the requesting user; and masking the selected portion of the content based on the user data.

7. The method of claim 1, wherein generating the modified version of the content of the group chat session includes selecting a portion of the content to be replaced and replacing the selected portion of the content with alternative content for presentation based on the user data.

8. An apparatus for presenting content history to a user added to a group chat, the apparatus comprising a computer processor, a computer memory operatively coupled to the computer processor, the computer memory having disposed within it computer program instructions that, when executed by the computer processor, cause the apparatus to carry out the steps of:
receiving a request from a requesting user to join an existing group chat session, wherein the requesting user is associated with user data describing the requesting user’s persona;
performing an analysis of content of the group chat session prior to the requesting user joining the group chat session; and
adding the requesting user to the group chat session, including:
generating a modified version of the content of the group chat session based on the content analysis and the user data, including modifying content history of the group chat session to be presented to the requesting user based on natural language processing (NLP) analysis of the content history; and
presenting the modified version of the content of the group chat session to the requesting user.

9. The apparatus of claim 8, wherein the user data comprises an identity of the requesting user and a role of the requesting user.

10. The apparatus of claim 8, wherein performing the analysis of the content of the group chat session includes performing natural language processing (NLP) on the content.

11. The apparatus of claim 10, wherein performing NLP on the content includes generating content tags associated with the content.

12. The apparatus of claim 10, wherein performing NLP on the content includes generating security tags associated with the content.

13. The apparatus of claim 8, wherein generating the modified version of the content of the group chat session includes selecting a portion of the content to be limited for presentation to the requesting user; and masking the selected portion of the content based on the user data.

14. The apparatus of claim 8, wherein generating the modified version of the content of the group chat session includes selecting a portion of the content to be replaced and replacing the selected portion of the content with alternative content for presentation based on the user data.

15. A computer program product for presenting content history to a user added to a group chat, the computer program product disposed upon a computer readable medium, the computer program product comprising computer program instructions that, when executed, cause a computer to carry out the steps of:
receiving a request from a requesting user to join an existing group chat session, wherein the requesting user is associated with user data describing the requesting user’s persona;
performing an analysis of content of the group chat session prior to the requesting user joining the group chat session; and
adding the requesting user to the group chat session, including:
generating a modified version of the content of the group chat session based on the content analysis and the user data, including modifying content history of the group chat session to be presented to the requesting user based on natural language processing (NLP) analysis of the content history; and
presenting the modified version of the content of the group chat session to the requesting user.

16. The computer program product of claim 15, wherein the user data comprises an identity of the requesting user and a role of the requesting user.

17. The computer program product of claim 15, wherein performing the analysis of the content of the group chat session includes performing natural language processing (NLP) on the content.

18. The computer program product of claim 17, wherein performing NLP on the content includes generating content tags associated with the content.

19. The computer program product of claim 17, wherein performing NLP on the content includes generating security tags associated with the content.

20. The computer program product of claim 15, wherein generating the modified version of the content of the group chat session includes selecting a portion of the content to be limited for presentation to the requesting user; and masking the selected portion of the content based on the user data.
